(19) United States
(12) Patent Application Publication
(10) Pub. No.: US 2022/0092693 A1
(43) Pub. Date: Mar. 24, 2022

(54) IDENTIFYING OVER-THE-COUNTER FINANCIAL TRANSACTIONS IN HUMAN CONVERSATIONS VIA COREFERENCE RESOLUTION

(71) Applicant: Green Key Technologies, Inc., Chicago, IL (US)

(72) Inventors: Amy ZUEND, Skokie, IL (US); Tejas SHASTRY, Chicago, IL (US)

(73) Assignee: Green Key Technologies, Inc., Chicago, IL (US)

(21) Appl. No.: 17/448,434

(22) Filed: Sep. 22, 2021

Related U.S. Application Data
(60) Provisional application No. 63/081,777, filed on Sep. 22, 2020.

(51) Int. Cl. G06Q 40/04; G10L 15/183; G10L 15/18; G10L 15/22; G10L 15/34; G06N 20/00

(52) U.S. Cl. CPC G06Q 40/04; G10L 15/183; G06N 20/00; G10L 15/22; G10L 15/34; G10L 15/1815

(57) ABSTRACT

Systems and methods herein provide for understanding the context of multiple conversation events and accurately linking them together. Such may allow for fewer financial transaction opportunities to be missed and enable sell side institutions to book more trades. In one embodiment, a method of classifying financial transaction messages with a trained machine learning model includes identifying entities in a financial transaction message, identifying subsequent passages relating to the financial transaction message, and classifying intent as valid or invalid in the financial transaction message. The method also includes linking events within a specific thread by sequentially processing the passages of the financial transaction message.

### CROSS REFERENCE TO RELATED APPLICATIONS

This patent application claims priority to, and thus the benefit of an earlier filing date from, U.S. Provisional Patent Application No. 63/081,777 (filed Sep. 22, 2021), the contents of which are hereby incorporated by reference as if repeated herein in entirety.

### BACKGROUND

Co-reference resolution is a natural language processing (NLP) task by which a named entity, such as John Smith, in a conversation is linked to references of that named entity, such as he or him, later in conversation. Co-reference resolution is used in many NLP systems. However, approaches thus far have focused on linking specific named entities together rather than ambiguous intents and events, which may be important in understanding financial conversations. For example, financial market participants often converse in multiparty digital chat rooms. Within a chat conversation, the goal of the participants is to come to agreement on a financial trade. Examples of message events that may occur in the chat conversation include: an inquiry from a party interested in a particular financial instrument (e.g., from a “buy side” participant); a quote in response with a price from a “sell side” participant at which they are willing to buy or sell; an agreement or negotiation of that price by the buy side participant; and a final confirmation from the sell side participant that the transaction is complete.

These messages are generally indicative of the stages of financial transaction negotiation. While a final trade is typically booked in a downstream system, negotiations where no trade occurs are often lost. These lost negotiations generally account for the vast majority of transactional conversations, and their identification can be valuable to a sell side institution looking to book more trades. However, linking these events together is challenging because any financial instrument, even though initially mentioned in the inquiry, is often absent from subsequent messages.

### SUMMARY

Systems and methods herein provide for understanding the context of multiple conversation events and accurately linking them together. Such may allow for fewer financial transaction opportunities to be missed and enable sell side institutions to book more trades. In one embodiment, a method of classifying financial transaction messages with a trained machine learning model includes identifying entities (e.g., features) in a financial transaction message, identifying subsequent passages relating to the financial transaction message, and classifying intent as valid or invalid in the financial transaction message. The method also includes linking events within a specific thread by sequentially processing the passages of the financial transaction message.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is an exemplary flow diagram of intents that may occur in a financial transaction.

FIG. 2 is a block diagram of an exemplary processing system for understanding the context of multiple conversation events and accurately linking them together.

FIG. 3. illustrates a series of messages that may occur in a multi-participant chat room during a financial transaction, in one exemplary embodiment.

FIGS. 4-8 illustrate the messages of FIG. 3 being processed by the processing system of FIG. 2, in one exemplary embodiment.

FIG. 9 is a flowchart of an exemplary process of the system of FIG. 1.

FIG. 10 is a block diagram of an exemplary computing system in which a computer readable medium provides instructions for performing methods herein.

### DETAILED DESCRIPTION OF THE FIGURES

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

The embodiments herein are operable to leverage natural language processing models to accomplish co-reference resolution of ambiguous intents. In some embodiments, the natural language processing maintains a shared identifier (e.g., a primary entity or a financial instrument) to accurately link events or passages of a financial transaction message (e.g., multiple chat conversations) together. For example, over-the-counter financial transactions are typically negotiated in chat rooms featuring multiple participants. These chat rooms often contain one or two individuals from a buy side institution and dozens of individuals from a sell side institution. Because of the diversity of participants and the nature of these conversations, two important phenomena frequently occur—divergence of intents and multi-threaded conversations.

With respect to divergence of intents, participants in financial chat conversations often have different goals depending on their institution. For example, buy side participants try fulfilling obligations to their investors to buy or sell assets at the best price. Because of this, buy side participants will frequently send the same inquiry to many sell side institutions. And, each sell side institution has a goal of completing a trade, and their performance is often measured by their quote to trade ratio. Thus, getting more trades with fewer quotes and/or reducing the number of rejected trades with the same number of quotes can maximize a desired outcome for a sell side participant.

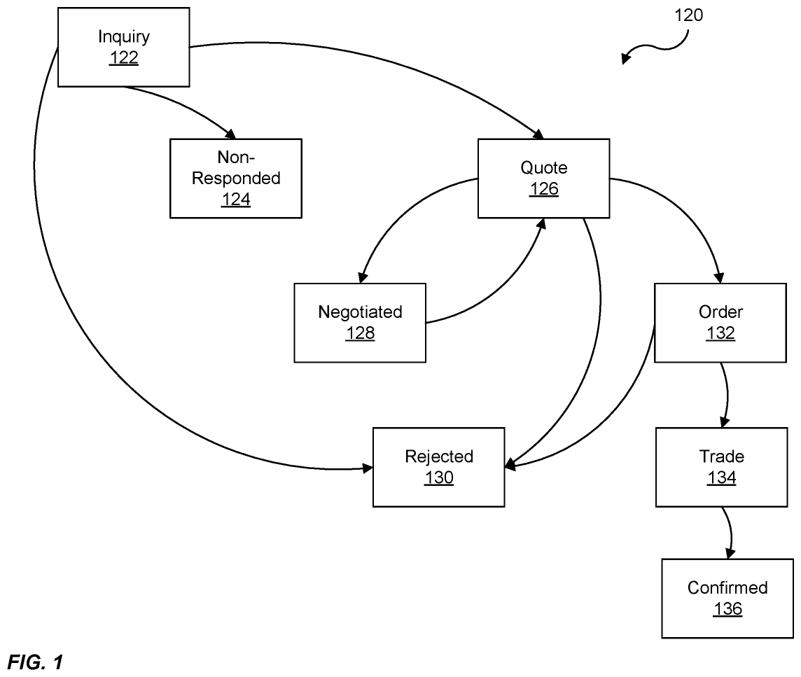

In some instances, either side may pose a particular intent. The branching of possible intents from an initial inquiry poses a challenge for models trying to link these instances together. And, a financial transaction negotiation can begin from either a buy side firm sending an inquiry or from a sell side firm proposing a quote. FIG. 1 illustrates the branching of possible intents, in one exemplary embodiment. In this embodiment, intent elements 122, 138, and 132 represent buy side entities and intent elements 124, 126, 134, and 136 represent sell side entities. And, the intent element 130 represents both buy side and sell side entities. Additionally, an entity co-reference resolution model operating on entities faces a distinct challenge in that co-referenced entities typically have one-to-many relationships and the observation of a new reference generally does not have further dependent derivative references.

Regarding multi-threaded conversations, co-reference resolution of financial transaction conversations is difficult due to the sheer number of participants. Because the conversations are multi-party, multiple simultaneous conversations of a transactional nature and/or a non-transactional nature may occur. Thus, a typical co-reference resolution model faces the challenge that references found in a particular message may relate to a different conversational thread than the appropriate one in question.

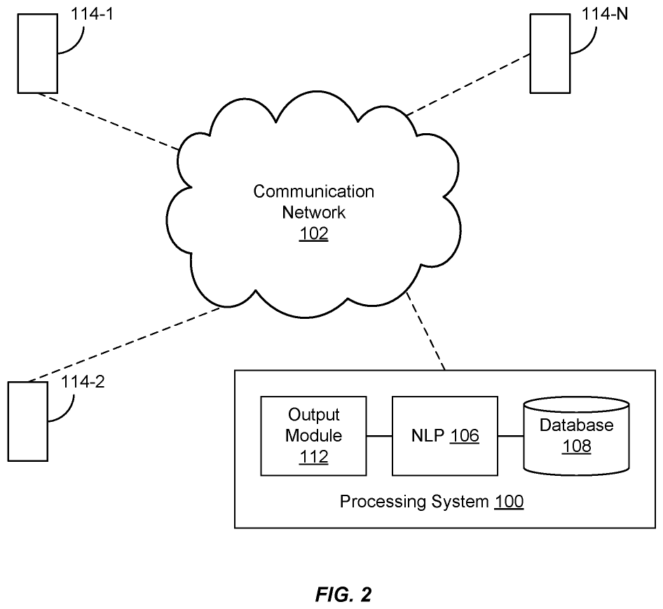

The embodiments herein provide for coreference resolution of intents via a multi-step approach. FIG. 2 illustrates an exemplary processing system 100 for implementing the multi-step approach. For example, given a conversation with timestamps, speakers, and messages, the processing system 100 may be operable to correctly link inquiries with subsequent trades as well as identify inquiries that were rejected along the way. The processing system 100 may include a natural language processor (NLP) 106 that comprises a machine learning model that is trained on intents and/or other features in chat conversations, or other text conversations, such as those illustrated in FIG. 1.

Some examples of machine learning algorithms that may be implemented by the NLP 106 to implement the machine learning model include a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network algorithm, a transfer learning algorithm, and an association rules algorithm.

In some embodiments, the NLP 106 is also operable to extract entities related to the financial transaction from a message. The NLP 106 may also identify conversational threads (e.g., in subsequent messages relating to the same topic) and sessions (e.g., subsequent messages with the same participants) within a multi-party conversation. Then, the NLP 106 may link events to validate/invalidate intents, link events within a specific thread using the entities extracted as an identifier (e.g., by proceeding sequentially through the messages), and/or expire event linkages based on session and thread boundaries.

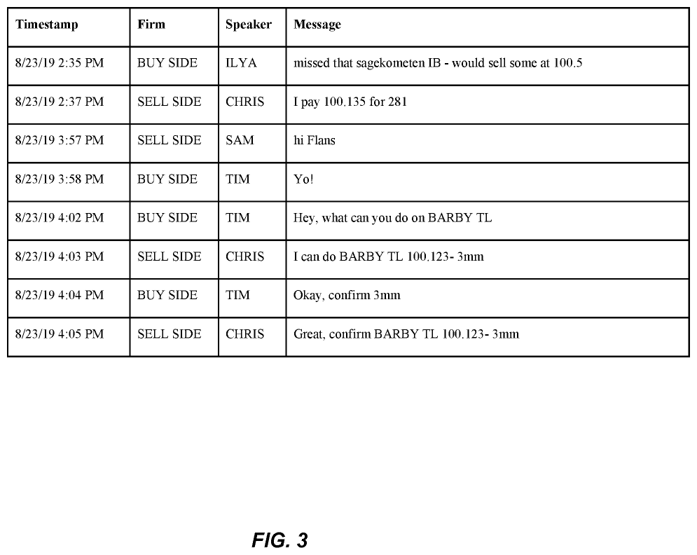

To illustrate, FIG. 3 shows an exemplary conversation of typical messages seen in a chat room that contains financial transactional discussions interspersed among other topics. The messages are generally configured with metadata (e.g., firm name, speaker, timestamp, and message) that the NLP 106 uses to link intents together. The firm name establishes whether a speaker is a buy side participant or sell side participant and thus establishes whether the speaker could be an initiator of a financial transaction negotiation via an inquiry or a quote. The NLP 106 may include a machine learning model that is operable to identify these metadata in the financial transaction messages. To do so, the NLP 106 may train the machine learning model from a relatively large number of financial transaction messages that are stored with the database 108 such that the NLP 106 can identify the metadata in the messages of FIG. 3.

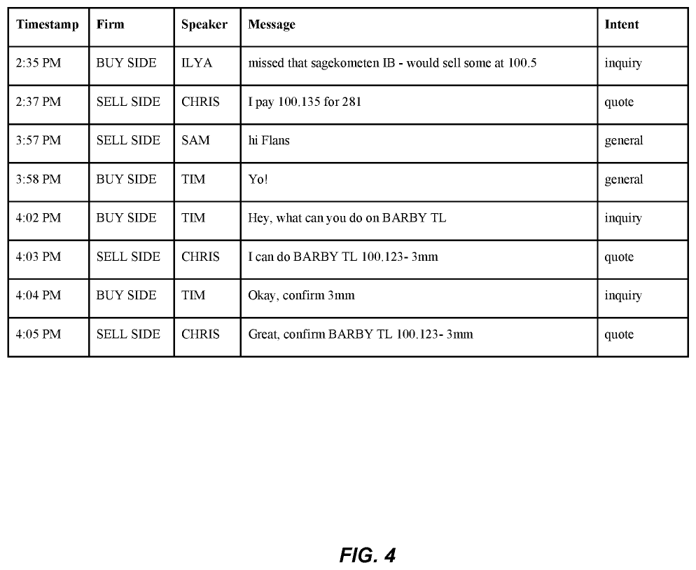

Generally, the first step in classifying the messages includes classifying the intents of the messages. The NLP 106 may use the trained machine learning model to classify the intents of subsequent messages. For example, the NLP 106 may process chatroom communications over a network 100 into from a plurality of user devices 114-1-114-N (where the reference “N” is an integer greater than “1” and not necessarily equal to any other “N” reference designated herein) so as to determine the intents of the users of those devices 114 (e.g., cell phones, tablet computers, and other computing devices). The NLP 106 may process the messages illustrated in FIG. 3 and label each of the messages with intents, as illustrated in FIG. 4.

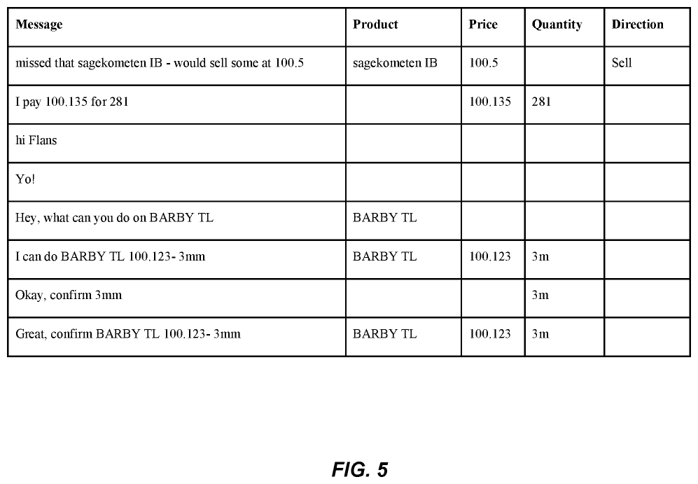

Next, the NLP 106 may extract features (a.k.a. entities) from the messages, such as product, price, quantity, and a directed instruction. These features may be useful as they may assist with identifying related intents. Again, the NLP 106 may employ a trained machine learning model (and/or some rule based model) to identify the features. Then, the NLP 106 may register the features to the message in a data structure as interpreted data, as illustrated in FIG. 5.

From there, the NLP 106 may identify conversational sessions and threads within a series of messages. For example, sessions are generally defined as temporally contiguous messages with a shared set of speakers. Threads on the other hand are generally defined as temporally contiguous messages with a shared topic. To identify threads, the NLP 106 may cycle through messages in an ascending temporal order. The NLP 106 may then map each intent to a topic. For example, some intents may be mapped to the topic “transaction”, while other intents may be mapped to a general/unknown intent to the topic “social” (e.g., a general conversation between parties). The NLP 106 may define a thread as any predefined criteria being met, provided that the duration between adjacent messages is not greater than a predetermined threshold value. This predefined criteria includes temporally contiguous messages with the same topic, temporally contiguous messages with two topics where the second topic has fewer than five successive messages (e.g., or fewer than three successive messages from more than one client), and a priority topic message preceded and followed by two or more non-priority topic messages.

Once the NLP 106 identifies the threads, messages within that thread may be assigned a thread ID (i.e., identification) and labeled with the majority topic. A “priority” topic, such as “transaction”, can also be set so that if any message is found with that topic, the entire thread can be labeled with the priority topic.

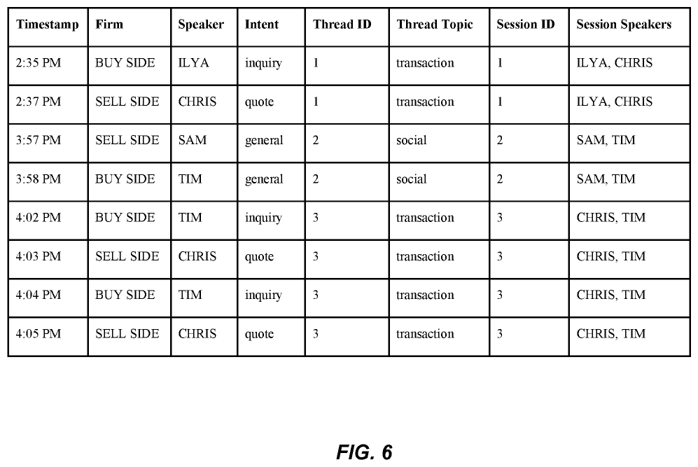

The NLP 106 may identify sessions by cycling through messages in ascending temporal order and identifying a session boundary. For example, the NLP 106 may determine that two messages are not part of the same session if a duration between messages is greater than a set value and/or if a duration between messages is greater than the average duration between messages and a subsequent message is part of a thread with messages from speakers that are not part of the preceding messages (i.e., speakers that are not part of a session). An example of the session and thread information is illustrated in FIG. 6.

The NLP 106 may then link intents together based on features and conversation information. For example, the NLP 106 may form a model that uses the intent, features, and thread data to validate the metadata around each message and link events. In this regard, the NLP 106 may label intents and corresponding features according to a set of rules that participants within the conversation follow. To illustrate, for a transactional conversation case, the NLP 106 may use a set of rules to label inquiries from buy side participants and quotes from sell side participants. The quotes contain either a price or quantity. And, multiple quotes in a row may be considered an artifact called a “run” that is not the direct response of an inquiry. The NLP 106 may relabel intents that do not accommodate these rules (e.g., into other intents outside of the scope of FIG. 1, such as market color, general, etc.).

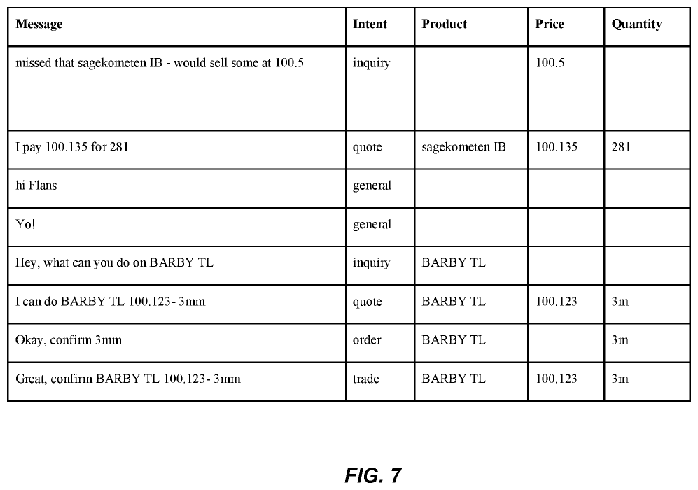

Once intents have been validated, the NLP 106 may track the lifecycle of intents to further establish whether intents are linked to previous events and/or are the start of a new event. In this regard, the NLP 106 may use the product and/or the thread/session to determine a new event in a transactional conversation. For example, the NLP 106 may force inquiries to begin with the introduction of a product. The NLP 106 may also link subsequent quotes to an inquiry by placing the product details within the inquiry row as long as the quote does not mention a different product. Inquiries and quotes that do not introduce a new product but come after a valid inquiry/quote pair may be determined to be orders or trades. And, the NLP 106 may initiate new events if a session or thread boundary is encountered. Taking these rules into account, the NLP 106 may relabel the data around the intent and features for the messages of FIG. 3, as shown in FIG. 7.

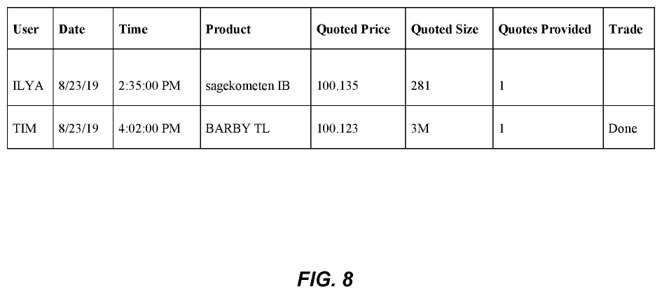

The NLP 106 may summarize the data and link inquiry events to final trades and events where no trade occurred and then output that information to the output module 112 of FIG. 2. Because the product details may be linked to the initial inquiry event, data can be directly queried to get a summary of transactions as per the list of transactions illustrated in FIG. 8.

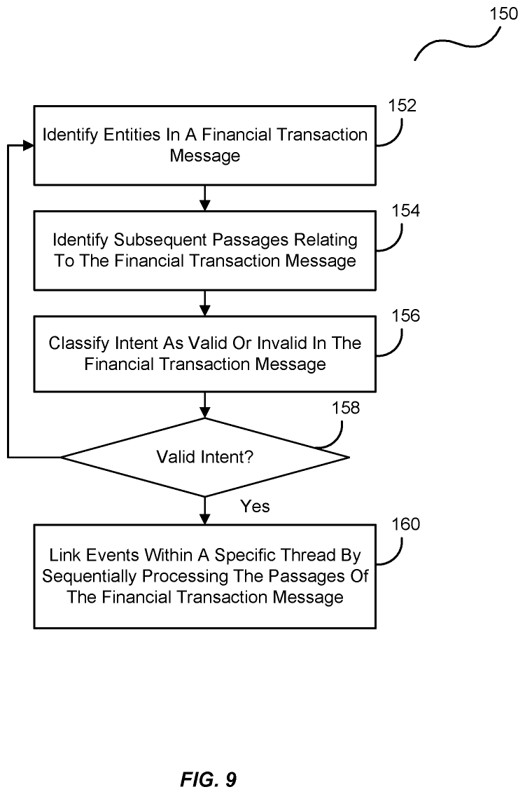

FIG. 9 is a flowchart of an exemplary process 150 of the processing system 100 of FIG. 2. In this embodiment, the NLP 106 identifies entities in a financial transaction message, in the process element 152. For example, the NLP 106 may comprise a machine learning model that has been trained with a plurality of messages retained in the database 108. The entities/features of the messages as well as their intents may be labeled as part of a supervised learning process such that the machine learning model may identify the entities/features and intents in subsequent messages. From there, the NLP 106 may use the trained machine learning model to identify subsequent passages (e.g., multiparty chat room texts) relating to the financial transaction message, in the process element 154. The NLP 106 may then classify the intent of the financial transaction message as being valid or invalid, in the process element 156. For example, the NLP 106 may link events into a contiguous dialogue to validate the intents of that dialogue. If the dialogue has been deemed invalid in the process element 158, the NLP 106 may discard the linked contiguous dialogue and reprocess the subsequent passages. Otherwise, the NLP 106 may establish the linked contiguous dialogue as valid and maintain the linked events thereof via the sequential processing of the passages of the financial transaction message, in the process element 160.

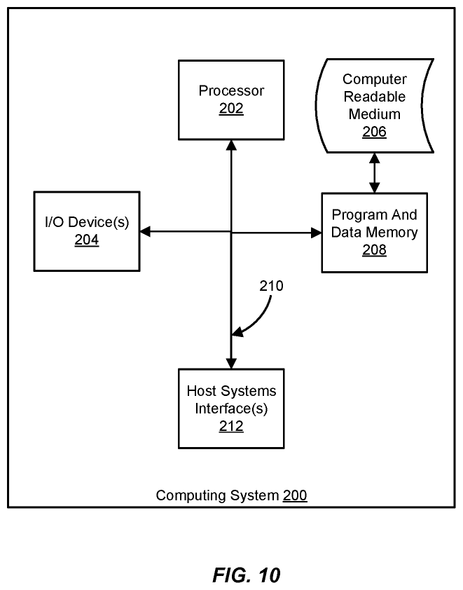

Any of the above embodiments herein may be rearranged and/or combined with other embodiments. Accordingly, the natural language processing concepts herein are not to be limited to any particular embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 10 illustrates a computing system 200 in which a computer readable medium 206 may provide instructions for performing any of the methods disclosed herein.

Furthermore, the embodiments can take the form of a computer program product accessible from the computer readable medium 206 providing program code for use by or in connection with a computer or any instruction execution system. For the purposes of this description, the computer readable medium 206 can be any apparatus that can tangibly store the program for use by or in connection with the instruction execution system, apparatus, or device, including the computer system 200.

The medium 206 can be any tangible electronic, magnetic, optical, electromagnetic, infrared, or semiconductor system (or apparatus or device). Examples of a computer readable medium 206 include a semiconductor or solid state memory, magnetic tape, a removable computer diskette, a random access memory (RAM), NAND flash memory, a read-only memory (ROM), a rigid magnetic disk and an optical disk. Some examples of optical disks include compact disk—read only memory (CD-ROM), compact disk—read/write (CD-R/W) and digital versatile disc (DVD).

The computing system 200, suitable for storing and/or executing program code, can include one or more processors 202 coupled directly or indirectly to memory 208 through a system bus 210. The memory 208 can include local memory employed during actual execution of the program code, bulk storage, and cache memories which provide temporary storage of at least some program code in order to reduce the number of times code is retrieved from bulk storage during execution. Input/output or I/O devices 204 (including but not limited to keyboards, displays, pointing devices, etc.) can be coupled to the system either directly or through intervening I/O controllers. Network adapters may also be coupled to the system to enable the computing system 200 to become coupled to other data processing systems, such as through host systems interfaces 212, or remote printers or storage devices through intervening private or public networks. Modems, cable modem and Ethernet cards are just a few of the currently available types of network adapters.

The instant description can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description is provided as an enabling teaching of the invention in its best, currently known aspect. Those skilled in the relevant art will recognize that many changes can be made to the aspects described, while still obtaining the beneficial results of the instant description. It will also be apparent that some of the desired benefits of the instant description can be obtained by selecting some of the features of the instant description without utilizing other features. Accordingly, those who work in the art will recognize that many modifications and adaptations to the instant description are possible and can even be desirable in certain circumstances and are a part of the instant description. Thus, the instant description is provided as illustrative of the principles of the instant description and not in limitation thereof.

As used herein, the singular forms “a,” “an” and “the” include plural referents unless the context clearly dictates otherwise. Thus, for example, reference to a “device” includes aspects having two or more devices unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects have been disclosed in the foregoing instant description, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

What is claimed is:

1. A method of classifying financial transaction messages with a trained machine learning model, the method comprising:
identifying entities in a financial transaction message;
identifying subsequent passages relating to the financial transaction message;
classifying intent as valid or invalid in the financial transaction message; and
linking events within a specific thread by sequentially processing the passages of the financial transaction message.

2. The method of claim 1, wherein event linkages are based on session and thread boundaries.

3. The method of claim 1, further comprising identifying a financial transaction in the financial transaction message.

4. The method of claim 1, wherein the financial transaction message includes an inquiry from a party interested in a particular financial transaction.

5. The method of claim 1, wherein the financial transaction message includes a quote in response to a price from a sell side participant at which the sell side participant is willing to buy.

6. The method of claim 5, wherein the financial transaction message includes an agreement or negotiation of price.

7. The method of claim 6, wherein the financial transaction message includes a final confirmation from the sell side participant that a transaction is complete.

8. The method of claim 1, further comprising classifying intents of each message before classifying each said message.

9. The method of claim 1, wherein the entities include price, product, quantity, or direction.

10. The method of claim 1, wherein sessions are defined as temporally contiguous messages with a shared set of speakers.

11. The method of claim 1, wherein sessions are defined as temporally contiguous messages with a shared topic.

12. The method of claim 11, wherein a model cycles through messages in ascending temporal order in a thread.

13. The method of claim 12, wherein the thread is defined as meeting criteria if a duration between adjacent messages is not greater than a set threshold value including:
temporally contiguous messages with the same topic;
temporally contiguous messages with two topics where the second topic has fewer than five successive messages; and
temporally contiguous messages with two topics where the second topic has fewer than three successive messages from more than one client, or a priority topic message preceded and followed by two or more non-priority topic messages.

14. The method of claim 13, wherein after all threads are identified, messages within the thread are assigned a thread ID and labeled with a majority topic.

15. The method of claim 14, wherein, in order to identify sessions, the model cycles through messages in ascending temporal order and identifies a session boundary if either of the following occurs:
a duration between messages is greater than a set value; or,
a duration between messages is greater than an average duration between messages and the subsequent message is part of a thread with messages from speakers that are not part of the preceding messages or part of a session.

16. A computer system, comprising:
a processor operable:
to identify entities in a financial transaction message; and
to identify subsequent passages relating to the financial transaction message, and
a machine learning module operable with the processor:
to classify intent as valid or invalid in the financial transaction message; and,
to link events within a specific thread by sequentially processing the passages of the financial transaction message.

17. A non-transitory computer readable medium comprising instructions that, when executed by a processor, direct the processor to implement a trained machine learning model to:
identify entities in the financial transaction message;
identify subsequent passages relating to the financial transaction message;
classify intent as valid or invalid in the financial transaction message; and
link events within a specific thread by sequentially processing the passages of the financial transaction message.

18. The non-transitory computer readable medium of claim 17 wherein the processor is a single-core processor.

19. The non-transitory computer readable medium of claim 17 wherein the processor is a multi-core processor.
